(19) United States
(12) Patent Application Publication
(10) Pub. No.: US 2019/0274342 A1
(43) Pub. Date: Sep. 12, 2019

(54) YOLKLESS HARD BOILDED EGG PRODUCT

(71) Applicant: Albert LI, (US)

(72) Inventor: Albert LI, Columbia, MD (US)

(73) Assignee: Albert LI, Columbia, MD (US)

(21) Appl. No.: 16/296,696

(22) Filed: Mar. 8, 2019

Related U.S. Application Data
(60) Provisional application No. 62/640,827, filed on Mar. 9, 2018.

(51) Int. Cl. A23L 15/00; A23P 30/10; A23L 5/42

(52) U.S. Cl. CPC A23L 15/20; A23L 15/30; A23V 2002/00; A23L 5/42; A23P 30/10

(57) ABSTRACT

The present disclosure provides a pre-cooked egg product; a yolkless egg-white food product. The pre-cooked egg product is a natural egg-white food product cooked in a geometric shape, which does not contain an egg yolk, including an artificial or simulated egg yolk. The pre-cooked natural egg-white food product optionally contains a food additive, such as coloring or flavoring, or optionally contains an artificial inner core that is a sweet, savory, meat, plant or dairy product.

### CROSS-REFERENCE TO RELATED APPLICATIONS

This application claims the benefit of U.S. Provisional Patent Application No. 62/640,827, filed on 9 Mar. 2018, the content of which is incorporated herein by reference in its entirety.

### FIELD OF THE INVENTION

The disclosed invention relates generally to pre-cooked natural egg-white food product prepared by cooking in a mold having a geometric shape.

### BACKGROUND OF THE INVENTION

Hard boiled eggs are routinely consumed either as breakfast, snack, appetizers, or as one of the foods served in gatherings (e.g. deviled eggs). In general, hard boiled eggs are prepared by boiling an unshelled egg and therefore would include both the egg while and egg yolk. While there is nutritious value associated with the yolk, many consumers prefer only the egg white either as a preference of taste, to avoid the additional calories, and to reduce dietary cholesterol and saturated fat intake. Egg whites contain about 56% of the protein in the egg which include albumins, mucoproteins, and globulins. Unlike the yolk, which is high in lipids (fats), egg white contains almost no fat, and carbohydrate content is less than 1%. Egg whites separated from the whole egg can be purchased commercially. The egg whites are generally consumed as an egg-white omelet, or as a paddy put into a sandwich. Hard-boiled egg-white as a pre-cooked food product is at this time not available. Accordingly, there remains a need for a nutritious pre-cooked egg-white food product available in a three-dimensional shape, such as in the shape of an egg.

The invention disclosed herein pertains to the manufacturing of a hard-boiled egg without a yolk by placing separated egg-white in a geometric-shaped mold and cooking the container. The resulting geometric shaped, including egg-shaped, hard-boiled “yolkless” egg is anticipated to be a food item to be consumed. The “yolkless” egg product has a high protein content, relatively mild taste and therefore can be fortified or supplemented with spices and flavoring to create interesting food items. It is a nutritious, high protein, low calorie food product for general consumption.

### SUMMARY OF THE INVENTION

Herein are provided pre-cooked natural egg-white food products and methods of preparing. In embodiments provided herein is a pre-cooked egg product, comprising natural egg-whites cooked in a geometric shape, wherein the egg product does not comprise a yolk of an egg or, a simulated or artificial egg yolk. In embodiments, the geometric shape is selected from an egg, sphere, cube, rectangle, pyramid, star, animal or animal part, a plant or plant part.

In certain embodiments provided herein is a pre-cooked egg product, comprising natural egg-whites cooked in a shape of an egg, wherein the egg product does not comprise a yolk of an egg or, a simulated or artificial egg yolk.

In certain embodiments, the natural egg-whites are from the egg of a chicken, quail, or duck. In embodiments, the pre-cooked egg product further comprises a flavoring, a sweetener or a colorant. In certain embodiments, the pre-cooked egg product further comprises a flavoring. In embodiments, those flavorings are selected from coffee, bacon, pepper, salt, cooking seasoning, curry powder, chili, or paprika.

In certain embodiments, the pre-cooked egg product further comprises an artificial inner core, wherein that artificial inner core comprises a sweet, savory, meat, plant or dairy product. In certain embodiments that artificial core is selected from; chocolate truffle, soft candy, honey; cake or pudding; from ham, sausage, chicken, pork, lamb, fish, fish roe, shell fish, shrimp, crab, caviar, lobster, or beef; from a vegetable or fruit; from milk, cream, cheese, or cottage cheese; or a combination thereof.

In certain embodiments, the pre-cooked egg food product is provided in a package or container. In embodiments is provided a container and a pre-cooked egg product enclosed in the container, wherein the pre-cooked egg product comprises natural egg-whites cooked in a geometric shape, wherein the egg product does not comprise a yolk of an egg or, a simulated or artificial egg yolk. In certain embodiments, the container contains at least one pre-cooked egg product, and up to 100 or more. In certain embodiments, the contain comprises 1 to 18 pre-cooked egg products.

Also provided herein are methods for preparing the pre-cooked natural egg-white food product. In embodiments, the methods comprise separating raw uncooked egg-whites from an un-broken yolk of an egg to form separated egg-whites; placing the separated egg-whites in a mold that is a geometric shape; and cooking the separated egg-whites in the shape of the mold to form the pre-cooked egg product. In embodiments, the cooking is in boiling water, steam, an oven, or via microwave energy. In certain embodiments, the manufacturing method is an automated process.

### DETAILED DESCRIPTION OF THE INVENTION

Provided herein are pre-cooked natural egg-white food products, packaging or containers containing same and methods of manufacturing the pre-cooked natural egg-white food product. Egg whites are also known as albumen or glair. The pre-cooked egg-white food products do not comprise a yolk of an egg (also known as the vitellus), including a simulated or artificial egg yolk. That is, the pre-cooked natural egg-white food product does not comprise components of natural egg yolk. In embodiments, the pre-cooked natural egg-white food product does not comprise dietary cholesterol; does not comprise dietary saturated fat such as palmitic acid, stearic acid, or myristic acid; does not comprise dietary fat-soluble vitamins such as vitamin A, vitamin D, vitamin E or vitamin K; does not comprise dietary unsaturated fat such as oleic acid, linoleic acid, palmitoleic acid or linolenic acid; does not comprise lecithin. In other words, the pre-cooked natural egg-white food product contains none of the negative dietary components of egg yolks (e.g., cholesterol and saturated fat) while maintaining the high protein content and cholesterol free benefits of natural egg-whites. The pre-cooked natural egg-white food product, as disclosed in more detail below, may be fortified either within the egg-white or in the form of an artificial inner core with certain beneficial dietary components (e.g. food additives), such as essential fatty acids, vitamins and minerals.

Natural egg whites are a source of low-fat, high-protein nutrition and contain protein, trace minerals, fatty material, vitamins, and glucose. Natural egg whites contain no cholesterol, or less than 1% w/v of cholesterol. Natural egg whites may contain one or more of the following proteins: ovalbumin, ovotransferrin, ovomucoid, ovoglobulin, or ovomucin. The natural egg white may be obtained from avian eggs, such as, but not limited to, chicken, quail or duck. In embodiments, the natural egg-whites are from chicken eggs. In embodiments, the natural egg whites of the present pre-cooked natural egg-white food products are separated from yolk of a chicken egg, a quail egg or a duck egg.

In embodiments provided herein is a pre-cooked egg product, comprising natural egg-whites cooked in a geometric shape, wherein the egg product does not comprise a yolk of an egg or, a simulated or artificial egg yolk. In embodiments, the geometric shape is a natural egg shape providing a pre-cooked egg product in the shape of an egg, but with no yolk and cooked in the absence of an egg shell. In certain embodiments, the geometric shape may be a sphere, cube, rectangle, pyramid, star, animal or animal part, a plant or plant part, or a fictional character. In certain embodiments, the geometric shape is not a patty shape. In other certain embodiments, the geometric shape is not an egg shape. One of skill in the art understands the geometric shape may be any three-dimensional shape and is not limited to those listed herein.

In certain embodiments, the natural egg-white, prior to pre-cooking, may be fortified with vitamins, minerals and healthy dietary fats such as unsaturated fat. The egg-white may also further comprise a food additive such as a flavoring, a sweetener, or a colorant. A sweetener such as honey, sugar or other sweetener used in cooking such as artificial sweeteners, may be added to the pre-cooked natural egg-white food product to provide a low-fat, high-protein dessert.

In embodiments, the pre-cooked natural egg-white food product further comprises food coloring or a color additive (also referred to herein as a colorant) that is compatible with natural egg-whites. The addition of a color additive provides a pre-cooked egg-white food product that is fun, attractive, appealing and appetizing. The color additive may be natural, such as pigments derived from natural sources such as vegetables, minerals, or animals. In other embodiments, the color additive is synthetic or artificial. One of skill in the art understands that synthetic food additives, which do not exist in nature, in the US, must be certified by the FDA and provided a FD&C number. Those numbers indicate that the FDA has approved the colorant for use in food, drugs and cosmetics. In the US, the following list of artificial color additives are generally permitted for use in food products: FD&C Blue No. 1—Brilliant Blue FCF, E133 (blue shade); FD&C Blue No. 2—Indigotine, E132 (indigo shade); FD&C Green No. 3—Fast Green FCF, E143 (turquoise shade); FD&C Red No. 3—Erythrosine, E127 (pink shade); FD&C Red No. 40—Allura Red AC, E129 (red shade); FD&C Yellow No. 5—Tartrazine, E102 (yellow shade) and FD&C Yellow No. 6—Sunset Yellow FCF, E110 (orange shade).

In embodiments, the pre-cooked egg-white food product further comprises a flavoring, which may be a natural flavoring, one derived from a plant or animal found in nature, or an artificial flavoring. Flavor food additives give a food product a particular taste or smell/odor and may be derived from natural ingredients or created artificially. In embodiments, a flavor additive may be added to the pre-cooked egg-white product to provide a specific odor/smell/taste, such as, but not limited to butter, fruit or plant (e.g., banana, grape, orange, pear, pineapple, apple, cherry, almond, mint or fruity), spice (e.g. cinnamon, vanilla) or sweet (e.g. cotton candy). One of skill in the art understands that thousands of artificial flavor compounds exist that can be used individually or combined to provide a desired taste/smell/odor to a food product and are not limited to those listed above. Moreover, artificial flavor additives may be combined with natural flavor additives to provide a pre-cooked egg white food product with a desired odor/smell/taste.

In certain embodiments, the pre-cooked egg-white food product further comprises a flavoring selected from coffee, bacon, pepper, salt, cooking seasoning, curry powder, chili, or paprika.

In embodiments, provided herein are pre-cooked egg-white food products that comprise an artificial inner core, wherein the artificial inner core is not a simulate or artificial egg yolk. In contrast, the artificial core is combined with the egg white to provide a food product that is a unique combination of pre-cooked egg white in a single unitary food product. In embodiments, the artificial inner core comprises a sweet, savory, meat, plant or dairy product. In certain embodiments the sweet product is selected from chocolate truffle, chocolate, soft candy, honey, cake or pudding; the meat product is selected from ham, sausage, chicken, pork, lamb, fish, fish roe, shell fish, shrimp, crab, caviar, lobster, or beef; the plant product is selected from a vegetable (e.g., spinach or cucumber) or fruit; and the dairy product is selected from milk, cream, cheese, yogurt, or cottage cheese. In embodiments, the artificial inner core comprises one or more of a sweet, savory, meat, plant, dairy product, or a combination thereof.

In embodiments, the pre-cooked natural egg white food product is provided in packaging or a container. The container may contain one, or more, pre-cooked natural egg-white food products in a geometric shape. The packaging or container may be provided wherein each pre-cooked natural egg-white food product is maintained separately (e.g. vacuum sealed in plastic bags), or each product may be provided in a container with an aqueous liquid, e.g. similar to a jar of pickles, or as components of a pre-packaged meal (e.g. salads).

In embodiments, the container comprises from one to 18 pre-cooked egg products. In certain embodiments, the container comprises up to 100 pre-cooked egg products. In certain other embodiments, the packaging or container comprises 1, 2, 3, 4, 5, 6, 7, 8, 9, 10, 11, 12, 13, 14, 15, 16, 17, 18, 19, 20, 21, 22, 23, 24, 25 ,26, 27, 28, 29, 30, 31, 32, 33, 34, 35, or 36 individual pre-cooked natural egg-white food products.

Further provided herein are methods of manufacturing a pre-cooked egg product comprising natural egg-whites cooked in a geometric shape, wherein the egg product does not comprise a yolk of an egg or, a simulated or artificial egg yolk, wherein the method comprises separating raw uncooked egg whites from an un-broken yolk of an egg to form separated egg-whites; placing the separated egg-whites in a mold that is a geometric shape; and, cooking the separated egg-whites in the shape of the mold to form the pre-cooked egg product. The egg whites may be separated from an un-broken yolk manually or using an automated process. The separated egg-whites are placed in a mold providing a three-dimensional shape to the cooked egg-white food product. The separated egg-whites may be placed in the mold manually or using an automated process. The geometric shape of the mold may be any shape known to one of skill in the art. There are no intended limits on the shape of the mold, which may include an egg, sphere, cube, rectangle, pyramid, star, animal or animal part, a plant or plant part, or a fictional character.

In embodiments provided herein is a method for manufacturing the pre-cooked egg product comprising natural egg-whites cooked in a geometric shape, wherein the egg product does not comprise a yolk of an egg or, a simulated or artificial egg yolk, wherein the method comprises separating raw uncooked egg whites from an un-broken yolk of an egg to form separated egg-whites; placing the separated egg-whites in a mold that is an egg shape; and, cooking the separated egg-whites in the shape of an egg to form the pre-cooked egg product.

In embodiments, the natural egg-white in the mold is cooked at a temperature and for a time period to provide cooked egg white. In certain embodiments, the egg-white filled molds are cooked in boiling water for a time period of 3 minutes to 15 minutes. In certain other embodiments, the egg white filled molds are cooked in steam for a time period of 3 minutes to 15 minutes. In other embodiments, the egg-white filled molds are cooked using microwave energy. In certain embodiments, the egg-white filled molds are cooked in an oven at a temperature from 70 to 120 deg. C.

Once cooked, the mold is removed to provide a pre-cooked natural egg-white food product. The individual pre-cooked egg white food products are optionally placed in a container or packaging.

In certain embodiments, a food additive (e.g. flavoring, color or sweetener) is added to the separated egg whites, either prior to placing in the mold or after in the mold but before cooking. In certain other embodiments, the manufacturing methods further comprise preparing an artificial inner core and placing in the mold. The separated egg-white is then placed in the mold after the prepared artificial core is placed in the mold. The artificial inner core may be cooked prior to placement in the mold, or it may be cooked at the same time as the egg white.

Accordingly, provided herein are methods for manufacturing a pre-cooked egg product comprising natural egg-whites cooked in a geometrical shape, wherein the egg product does not comprise a yolk of an egg or, a simulated or artificial egg yolk, wherein the method comprises, i) optionally preparing an artificial inner core and placing in a mold; ii) separating raw uncooked egg-whites from an un-broken yolk of an egg to form separated egg-whites; iii) optionally adding a food additive to the separated egg-whites; iv) placing the separated egg-whites in a mold that is a geometric shape; and, v) cooking the separated egg-whites in the shape of the mold to form the pre-cooked egg product.

Those skilled in the art can devise many modifications and other embodiments within the scope and spirit of the presently disclosed inventions. Indeed, variations in the materials, methods, and embodiments disclosed may be made by skilled artisans without changing the fundamental aspects of the disclosed inventions. Any of the disclosed embodiments can be used in combination with any other disclosed embodiment. The disclosed embodiments are not intended to limit the scope of the disclosure

1. A pre-cooked egg product, comprising natural egg-whites cooked in a geometric shape, wherein the egg product does not comprise a yolk of an egg or, a simulated or artificial egg yolk.

2. The egg product of claim 1, wherein the egg-whites are from chicken, quail, or duck eggs.

3. The egg product of claim 1, wherein the geometric shape is selected from an egg, sphere, cube, rectangle, pyramid, star, animal or animal part, a plant or plant part or a fictional character.

4. The egg product of claim 1, further comprising a flavoring, a sweetener or a colorant.

5. The egg product of claim 4, wherein the flavoring is coffee, bacon, pepper, salt, cooking seasoning, curry powder, chili, or paprika.

6. The egg product of claim 4, wherein the colorant is a natural colorant.

7. The egg product of claim 4, wherein the colorant is selected from FD&C Blue No. 1—Brilliant Blue FCF, E133 (blue shade); FD&C Blue No. 2—Indigotine, E132 (indigo shade); FD&C Green No. 3—Fast Green FCF, E143 (turquoise shade); FD&C Red No. 3—Erythrosine, E127 (pink shade); FD&C Red No. 40—Allura Red AC, E129 (red shade); FD&C Yellow No. 5—Tartrazine, E102 (yellow shade) or FD&C Yellow No. 6—Sunset Yellow FCF, E110 (orange shade).

8. The egg product of claim 1, further comprising an artificial inner core, wherein the artificial inner core comprises a sweet, savory, meat, plant or dairy product.

9. The egg product of claim 8, wherein the sweet product is selected from chocolate truffle, soft candy, honey, cake or pudding.

10. The egg product of claim 8, wherein the meat product is selected from ham, sausage, chicken, pork, lamb, fish, fish roe, shell fish, shrimp, crab, caviar, lobster, or beef.

11. The egg product of claim 8, wherein the plant product is selected from a vegetable or fruit.

12. The egg product of claim 8, wherein the dairy product is selected from milk, cream, cheese, or cottage cheese.

13. (canceled)

14. (canceled)

15. (canceled)

16. A pre-cooked egg product, comprising natural egg-whites cooked in a geometric shape, wherein the egg product does not comprise a yolk of an egg or, a simulated or artificial egg yolk, with the proviso the geometric shape is not an egg shape or a patty shape.

17. A container and a pre-cooked egg product enclosed in the container, wherein the pre-cooked egg product comprises natural egg-whites cooked in a geometric shape, wherein the egg product does not comprise a yolk of an egg or, a simulated or artificial egg yolk.

18. The container of claim 17, comprising 1 to 100 pre-cooked egg products.

19. The container of claim 17, wherein the container is a glass jar comprising pre-cooked egg products and an aqueous liquid.

20. The container of claim 17, wherein the container comprises pre-cooked egg products individually vacuumed sealed.

21. The container of claim 17, wherein the container comprises plastic or cardboard.

22-32. (canceled)

33. A method of manufacturing the pre-cooked egg product of claim 1, comprising:
separating raw uncooked egg-whites from an un-broken yolk of an egg to form separated egg-whites;
placing the separated egg-whites in a mold that is a geometric shape; and,
cooking the separated egg-whites in the shape of the mold to form the pre-cooked egg product.

34. (canceled)

35. (canceled)

36. The method of claim 33, wherein the geometric mold shape is selected from an egg, sphere, cube, rectangle, pyramid, star, animal or animal part, a plant or plant part, or a fictional character.

37-46. (canceled)
